(19) United States
(12) Patent Application Publication
(10) Pub. No.: US 2024/0428119 A1
(43) Pub. Date: Dec. 26, 2024

(54) MACHINE LEARNING TIME-SERIES DATA RECONSTRUCTION

(71) Applicant: ServiceNow, Inc., Santa Clara, CA (US)

(72) Inventors: Lorne Schell, Montreal (CA); Étienne Marcotte, Montréal (CA); Benjamin Crestel, Montreal (CA); Seyed Hamed Yaghoubi Shahir, Ontario (CA)

(21) Appl. No.: 18/214,340

(22) Filed: Jun. 26, 2023

(51) Int. Cl. G06N 20/00

(52) U.S. Cl. CPC G06N 20/00

(57) ABSTRACT

A distribution of values of time-series data is obtained. Based on the distribution of the values, the time-series data is sampled to generate an anomaly preserving version of the time-series data. Via a trained machine learning model, a reconstructed version of the time-series data is generated based on the anomaly preserving version of the time-series data.

### BACKGROUND OF THE INVENTION

Machine learning involves training a prediction model from possibly large bodies of feature data. Depending on the model, a different number of input features can be utilized. For example, some models can utilize a small number of input features while others can utilize hundreds or more different input features. Once a model is trained using the specified input features, a trained machine learning model can be used by a machine learning prediction server to perform predictions to solve a machine learning problem. Based on the particular machine learning problem, different machine learning models can be utilized by a prediction server to predict the appropriate result.

### BRIEF DESCRIPTION OF THE DRAWINGS

Various embodiments of the invention are disclosed in the following detailed description and the accompanying drawings.

FIG. 1 is a block diagram illustrating an example of a network environment for automatically training a machine learning model for anomaly detection.

FIG. 2 is a flow chart illustrating an embodiment of a process for creating a machine learning solution.

FIG. 3 is a flow chart illustrating an embodiment of a process for preparing input data for a machine learning solution.

FIG. 4 is a flow chart illustrating an embodiment of a process for generating a reconstructed version of time-series data.

FIG. 5 is a flow chart illustrating an embodiment of a process for creating a model for reconstructing time-series data.

FIG. 6 is a flow chart illustrating an embodiment of a process for creating a sampled data set that preserves anomalies.

FIG. 7 is a functional diagram illustrating a programmed computer system for providing a machine learning solution.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The reconstruction of time-series data using a trained machine learning model is disclosed. For example, using the disclosed techniques, time-series data can be compressed and stored using a trained machine learning model and a related anomaly preserving version of the time-series data. In some embodiments, the original time-series data is analyzed and sampled to construct a sampled version of the data that preserves properties of the time-series data such as anomalies and/or outliers. In some embodiments, the data is sampled based on properties of the data values such as changes in the rate of change in the data values and/or inflection points in the data values, among other properties. In various embodiments, the sampled data oversamples from underrepresented values in the time-series data in order to preserve the unique properties of the data. Using the sampled data along with the time-series data, a model can be trained to reconstruct a version of the original time-series data. For example, when the trained model is provided with the sampled data that preserves anomalies, the trained model can generate a version of the original time-series data that accurately reflects the desired preserved properties and/or characteristics of the time-series data. The reconstructed data can be further used as training data such as to train a second machine learning model to detect anomalies and/or other properties from the time-series data. For example, a second machine learning model can be trained using the reconstructed data along with newly collected data (if appropriate and/or available) to accurately train a model for anomaly detection. By storing the trained model and the sampled data, a compact representation of the original data can be stored and then a version of the original data can be subsequently generated, as needed, using the trained model and sampled data. Moreover, using the disclosed techniques, the original time-series data does not need to be retained and can be securely deleted, for example, to conform to data retention policies and address issues such as security and/or privacy concerns. In some embodiments, multiple pairs of trained models and associated sampled data sets can be prepared and stored for providing anomaly detection based on different deployment configurations, such as a different trained model and sample data pair for each different hardware and/or software combination.

In some embodiments, a distribution of values of time-series data is obtained. For example, potential training data is collected and/or prepared. The collected data is time-series data such as running metrics associated with a device being monitored for anomalies. Example metrics can include CPU speed, CPU temperature, memory usage, network utilization, swap size, and the running processes, among others. In various embodiments, the time-series data is analyzed to determine a distribution of the data. The distribution can identify and differentiate between metrics that are close to the mean and those that are further from the mean such as outliers. For example, metrics that are statistical outliers can be identified as statistical anomalies. In some embodiments, based on the distribution of the values, the time-series data is sampled to generate an anomaly preserving version of the time-series data. For example, a sample of the time-series data is generated that includes and/or overrepresents values outside the mean, such as values outside one or two standard deviations from the mean. Unlike traditional sampling techniques, where mean values are highly represented, the anomaly preserving version of the time-series data includes significant samples of non-mean values in order to preserve anomalous and/or outlining values. Metric values that are typically underrepresented by traditional sampling techniques are included in the anomaly preserving version of the time-series data. In various embodiments, the sampled data is an anomaly preserving version of the time-series data but utilizes a significantly smaller amount of storage and/or is a smaller size than the time-series data.

In some embodiments, via a trained machine learning model, a reconstructed version of the time-series data is generated based on the anomaly preserving version of the time-series data. For example, a multi-variate machine learning model is trained using the anomaly preserving version of the time-series data to reconstruct a version of the original time-series data. The reconstructed version may not be identical to the original time-series data but will preserve anomalous values. For example, the reconstructed version can include the same distribution of anomalous values as the original data. In some embodiments, the machine learning model is trained using both the anomaly preserving version of the time-series data as well as the time-series data, such as a version of the original and/or full time-series data prepared as training data. In order to reconstruct the time-series data, the trained model can be provided with the anomaly preserving version of the time-series data as input. In some embodiments, only the trained model and the anomaly preserving version of the time-series data are needed in order to reconstruct a version of the original time-series data. By storing both the trained model and the anomaly preserving version of the time-series data instead of the original time-series data, significant storage resources are saved. In some embodiments, the trained machine learning model is an auto-encoder and when applied with the anomaly preserving version of the time-series data, the model functions as a solution for retrieving a version of the original time-series data using a compressed input source. In various embodiments, the trained machine learning model paired with the anomaly preserving version of the time-series data are sufficient to reconstruct at least a lossy version of the time-series data that preserves anomalous values.

In some embodiments, the reconstructed version of the time-series data generated by the trained machine learning model when the model is provided with the anomaly preserving version of the time-series data is used at least in part as training data for training a second machine learning model for detecting anomalies. Using the second trained machine learning model, time-series data can be analyzed for properties such as anomalies. For example, the reconstructed version of the time-series data closely matches actual monitored metrics, such as live and/or real-time monitored metrics of a particular device with a particular configuration. In various embodiments, the reconstructed data is prepared as training data since it specifically includes representative anomalies of the time-series data. Consequently, the second trained machine learning model can be used to predict properties of time-series data such as anomalies. In some embodiments, models are trained to preserve anomalies based on configuration type. For example, each asset such as a hardware and/or software combination can be assigned as a configuration item with a specific configuration item type, and a different model can be trained using a relevant and/or associated anomaly preserving version of time-series data for each configuration item and/or configuration item type. In some embodiments, a corresponding trained model and anomaly preserving version of time-series data is stored for each configuration item type, and the model and data pair can be retrieved as needed to reconstruct a version of time-series data for the configuration item type and/or associated configuration item. In some embodiments, the reconstructed version of time-series data is used to train the second machine learn model for detecting anomalies relevant for the configuration item type.

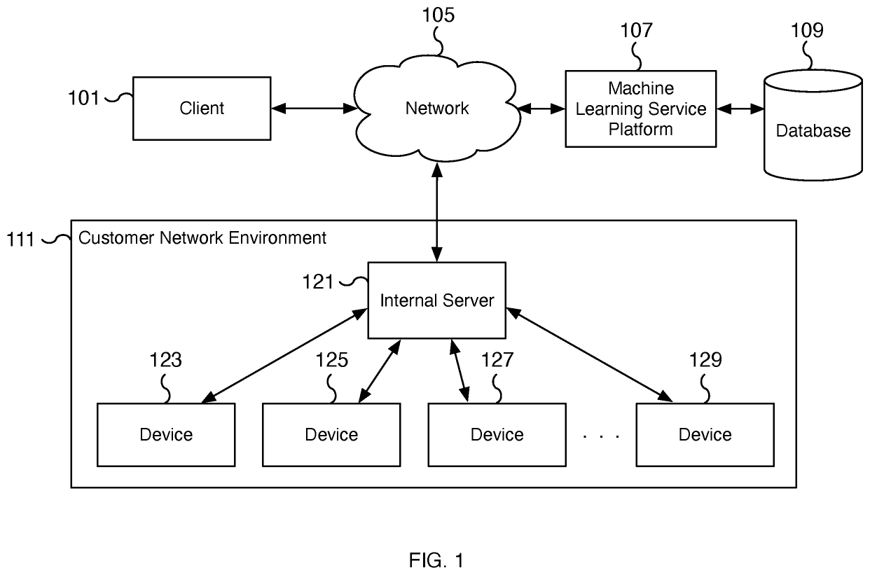

FIG. 1 is a block diagram illustrating an example of a network environment for automatically training a machine learning model for anomaly detection. In the example shown, client 101, machine learning service platform 107, and customer network environment 111 are connected to network 105. Network 105 can be a public or private network. In some embodiments, network 105 is a public network such as the Internet. In various embodiments, machine learning service platform 107 is a cloud-based machine learning service that utilizes database 109, which is communicatively connected to machine learning service platform 107. In some embodiments, database 109 is part of machine learning service platform 107. Customer network environment 111 includes internal server 121 and multiple customer devices including devices 123, 125, 127, and 129. Client 101 utilizes machine learning service platform 107 to initiate, manage, and/or deploy machine learning services for detecting anomalies associated with customer network environment 111. For example, client 101 allows an operator of customer network environment 111 to remotely manage machine learning services for anomaly detection. Although the example network environment of FIG. 1 is used for anomaly detection, using the disclosed techniques, the same and/or similar network environments and platforms can be used to train and apply machine learning models for other machine learning problems.

In some embodiments, machine learning service platform 107 provides cloud-based machine learning services including services related to anomaly detection for a network environment such as customer network environment 111. Machine learning service platform 107 can be accessed by network clients (not necessarily shown) that reside within or outside customer network environment 111. For example, in some embodiments, client 101 is located within customer network environment 111. Using machine learning service platform 107, an operator can train and/or deploy a machine learning model for anomaly detection. When a trained model is deployed, the machine learning service can identify anomalies and trigger an appropriate response including sending notifications to the appropriate operators of the network and/or automatically reconfiguring the network to account for a detected anomaly.

In various embodiments, machine learning service platform 107 can train a machine learning model to perform anomaly detection for a network environment at least in part by receiving and/or generating the relevant training data. For example, data related to the applicable network environment, such as customer network environment 111, can be collected and provided to machine learning service platform 107 where it is eventually utilized by machine learning service platform 107 as training data. Rather than storing the potential training data in its raw format, the potential training data can be stored and/or compressed using the disclosed techniques. For example, the potential training data can be sampled and the sampled data can be used to train a model that is capable of reconstructing a version of the original data (i.e., the potential training data). In some embodiments, the model is trained using the original data and the sampled data is an anomaly preserving reduced version of the data. A reconstructed version of the original data can then be generated by applying the sampled data to the trained model. In some embodiments, the trained model is an autoencoder. In various embodiments, only the trained model and the sampled data need to be stored in order to generate a version of the original training data. For example, the trained model and sampled data pair can then be used to reconstruct the collected data for use in training a model to solve a machine learning problem. By storing specifically the trained model and sampled data pair rather than the raw original data, the overall storage requirements are significantly reduced and the original data does not need to be retained. In some embodiments, the reconstructed data is combined with additional collected data and both data sets are used as potential training data. For example, the reconstructed data corresponds to historical data (such as data representative of past and/or seasonal trends) and the additional collected data corresponds to more recently collected data (such as data representative of current trends). In various embodiments, the training data is used to train the machine learning model for solving a machine learning problem such as anomaly detection. The trained machine learning model can be a multi-variate model.

In some embodiments, each device of machine learning service platform 107 can be assigned one or more configuration items, such as a combination of software and/or hardware assets. Moreover, each configuration item can be assigned a configuration item type that categorizes a configuration item. In various embodiments, a different machine learning model is trained for each configuration item type in order to reconstruct the training data required to train a model for the configuration item type and its associated configuration items. For example, a deep learning model can be trained for each configuration item type to detect anomalies for configuration items having the configuration item type. By storing a trained model and sampled data pair for each configuration item type, training data can be generated to train a model for each configuration item based on configuration item type. In some alternative embodiments, a universal model is instead trained for all configuration item types and only the sampled data is unique between different configuration item types.

In various embodiments, database 109 provides persistent storage for a customer with respect to various managed machine learning services. Each different customer of machine learning service platform 107 may utilize a different data store mechanism such as different databases, database instances, or database partitions or tables. In some embodiments, database 109 is a configuration management database (CMDB) for providing customer services and storing customer data. For example, database 109 can store customer data related to the network environment including training data and/or other data used to predict anomalies including input features for various machine learning models. In some embodiments, database 109 can store customer configuration information related to managed assets, such as related hardware and/or software configurations. In some embodiments, database 109 is used to store training data for training machine learning models. For example, database 109 can store a trained model and sampled data from an original data set, such as collected metrics from monitoring a configuration item. The trained model and sampled data can be used to generate a version of the original data, for example, for use as training data.

In some embodiments, customer network environment 111 is an information technology network environment and includes multiple hardware devices including devices 123, 125, 127, and 129, as examples. In various embodiments, the devices of customer network environment 111, such as devices 123, 125, 127, and 129, can run application processes that interact with one another and/or with other computing devices outside of customer network environment 111. In the example shown, internal server 121 is capable of initiating and/or receiving network connections to and/or from each of devices 123, 125, 127, and 129 (as shown by the arrows pointing from/to internal server 121 to/from the respective devices 123, 125, 127, and 129). Using internal server 121, data including operating data of the different devices of customer network environment 111 such as devices 123, 125, 127, and 129 is gathered and used to predict anomalies. For example, internal server 121 can gather operating data from the various devices and provide the data to machine learning service platform 107 for both training and potentially inference. In some embodiments, the inference to predict anomalies is performed at internal server 121 and/or by machine learning service platform 107. Examples of gathered data can include hardware operating data such as data related to CPU, GPU, networking, memory, storage, and power consumption data as well as software operating data such as data related to active threads/processes, active users, page views, page clicks, bounce rates, churn rates, average order values, connected users, connection times of users, etc. In various embodiments, the data is continually gathered at internal server 121 to predict future events such as an anomaly.

In some embodiments, agents and/or other processes are deployed on the various devices such as devices 123, 125, 127, and 129 to collect the input data used for machine learning. For example, a log scanning agent can scan the logged output of a process running on a device and provide the results to internal server 121. As another example, an agent can monitor the operation of a running process, such as data related to memory usage, disk access, and/or threads/processes, and provide the results to internal server 121. In some embodiments, custom data values are gathered by a customer and fed to the machine learning service. For example, one or more custom agents can be deployed within customer network environment 111 to collect data and/or calculate different data properties related to customer network environment 111. The collected data is provided to internal server 121 and/or machine learning service platform 107 as a single unlabeled input feature and/or as a collection of unlabeled input features. In various embodiments, the collected data is processed and/or stored by machine learning service platform 107 and can be utilized for training and/or inference.

In some embodiments, the components shown in FIG. 1 may exist in various combinations of hardware machines. Although single instances of some components have been shown to simplify the diagram, additional instances of any of the components shown in FIG. 1 may exist. For example, machine learning service platform 107 can include one or more cloud-based servers. Some servers of machine learning service platform 107 may include web application servers, machine learning training servers, and/or machine learning inference servers. As shown in FIG. 1, the various servers are simplified as machine learning service platform 107. Similarly, database 109 may not be directly connected to machine learning service platform 107, may be more than one database, and/or may be replicated or distributed across multiple components. For example, database 109 may include one or more different servers for each customer. For customer network environment 111, additional or fewer devices may exist and some components, such as a firewall and/or gateway device, may exist but are not shown. As another example, client 101 is just one example of a potential client to machine learning service platform 107. In some embodiments, components not shown in FIG. 1 may also exist.

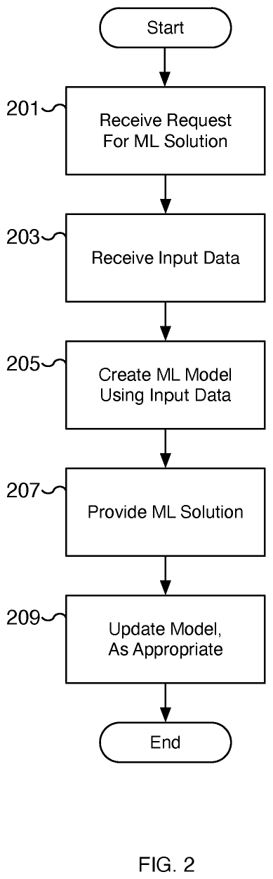

FIG. 2 is a flow chart illustrating an embodiment of a process for creating a machine learning solution. For example, using the process of FIG. 2, an operator can request a machine learning solution by providing input data to train a custom machine learning model. Example custom trained machine learning models include models for detecting anomalies for specific network computer environments and their devices and/or assets. The created solution can include both a custom trained machine learning model as well as a trained reconstruction model to generate a version of the provided input data as training data. The trained reconstruction model can be particularly helpful when updating the model for the machine learning solution. For example, the trained reconstruction model can generate training data for training an updated machine learning solution model rather than storing and using the original input data as training data. In some embodiments, the machine learning platform for creating the machine learning solution is hosted as a software-as-a-service machine learning service. In some embodiments, the machine learning platform is machine learning service platform 107 of FIG. 1. In some embodiments, an operator requests the solution via a client such as client 101 of FIG. 1 and the requested machine learning solution includes a custom trained model for anomaly detection applied to an environment such as customer network environment 111 of FIG. 1

At 201, a request for a machine learning solution is received. For example, an operator via a network client initiates a request for a machine learning solution to a software-as-a-service machine learning service platform. In some embodiments, the user interface for providing the request is a web application. As part of the request, the machine learning service platform receives information on the data that will be provided for training the model. For example, the operator can specify how to receive the data such as what network device will be providing the data and the format of the data.

At 203, input data for machine learning is received. For example, input data to be used as input features for training a machine learning model is received. In various embodiments, the input data is time-series data collected over a certain period of time. For example, the input data used for anomaly detection can be time-series data gathered at the customer's network computer environment over an elapsed period of time and can be specific to the customer's network computer environment. In some embodiments, the provided input data includes values captured in real-time or near real-time including real-time and run-time operating values. Example input data includes metrics data related to hardware, software, and user data. Examples of hardware operating values include values related to CPU, GPU, memory, storage, and network operations. Similarly, software operating values can include values related to processes/threads, applications, memory usage including virtual memory usage, idle time, etc. Examples of user data can include data related to active users, page views, page clicks, bounce rates, churn rates, average order values, connected users, connection times of users, etc. In various embodiments, the provided input data can be unlabeled and can include a variety of data as determined by the operator. In some embodiments, the input data used for training a machine learning model includes at minimum a month's worth of gathered operating data. By gathering data for at least a month long, the included input data captures at least the monthly cyclical patterns, such as the monthly cyclical patterns of a network computer environment. In various embodiments, models trained with data that spans at least a month long have significantly improved accuracy and precision.

In some embodiments, custom data values are gathered by a customer and provided to the machine learning service platform as input data. For example, one or more custom agents can be deployed within the customer's network computer environment to collect data and/or calculate different data properties related to the customer's network computer environment. The collected data is provided as a single unlabeled input feature and/or as a collection of unlabeled input features.

At 205, a machine learning model is created using the received input data. For example, a machine learning model is trained using the input data received at 203. In various embodiments, the input data is prepared and preprocessed to generate training data. In some embodiments, the data is compressed and stored using a trained model such as an autoencoder. The trained model can then be used to generate a version of the input data when the input data is needed for training (such as for the original training of the model and/or for updates to the model). In various embodiments, a custom model is trained for solving a machine learning problem using the received input data and/or a version of the input data. The model can be trained using unsupervised training and can be used, for example, to predict a normality score. In some embodiments, the trained model is a multi-variate machine learning model, such as a multi-variate machine learning model for anomaly detection. For example, in the context of anomaly detection, a multi-variate model can be trained to predict a single score that corresponds to how “normal” the perceived operation is of the customer's network computer environment using multiple input features with the number of input features ranging from tens to hundred or more features. Based on the normality score, an anomaly activation value can be automatically determined. For example, by arranging predicted normality scores as a histogram, peaks can be identified and used to determine a threshold activation value. The automatically determined anomaly activation value is applied as a threshold to predicted normality scores to determine whether an anomaly is detected. For example, a predicted normality score that exceeds the anomaly threshold corresponds to the occurrence of an anomaly for the customer's network computer environment. Additional specific training techniques can be utilized to improve the performance of the model for anomaly detection and/or the specific machine learning application.

At 207, a machine learning solution is provided. For example, the trained model and any required deployment parameters, such as an automatically determined threshold activation value, are provided. In some embodiments, the model is deployed as part of a machine learning service and inference is performed by the machine learning service platform using cloud-based machine learning inference servers. In various embodiments, the trained model is provided as a service with the corresponding automatically determined threshold values to allow the customer to predict desired results such as anomalies for the customer's network computer environment in real-time.

At 209, the machine learning model is updated, as appropriate. For example, the computer network environment may have changed, and newly gathered input data can be used to retrain the model to better reflect current operating conditions. As another example, an operator can provide feedback on the performance of the deployed model that is used to revise the model. For example, an operator can provide feedback on model performance including confirmations of whether predicted results, such as detected anomalies, correspond to accurate results, such as actual anomalies. As part of revising the model, a corresponding threshold activation value can be automatically determined. If a model revision is appropriate, both the updated model and any corresponding threshold values are provided for deployment. In some embodiments, in the event the model is retrained, the stored version of the reconstruction model can be used to generate a version of the original input data. The generated version of the input data can be used in full or in part and may be combined with optional additional training data (such as new training data) to retrain a machine learning model. In some embodiments, a sampled data of the original input data, such as an anomaly preserving version of the input data, is used with the reconstruction model to generate the original input data.

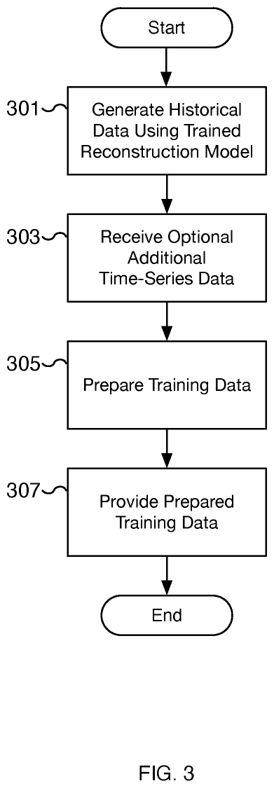

FIG. 3 is a flow chart illustrating an embodiment of a process for preparing input data for a machine learning solution. For example, using the process of FIG. 3, input data is received by a machine learning platform and prepared as training data to train a machine learning model. In various embodiments, the type of input data received corresponds to the data used for machine learning training and inference. In some embodiments, the received input data corresponds to data received at different times. For example, a first set of input data can correspond to historical data and a second set of input data can correspond to more recent data. In some embodiments, the input data corresponds to metrics captured from monitoring one or more configuration items of the network environment having a specific configuration item type. The historical set of input data can correspond to data more than three months old, and a second set of more recent input data can correspond to data captured from the last three months. The two (or more) sets of input data can be utilized together to train a machine learning model. In some embodiments, one or more of the input data sets, such as the historical data, can be stored using the disclosed techniques at least in part by sampling the data using an anomaly preserving sampling technique. For example, using the process of FIG. 3, a version of the stored data is retrieved and then prepared and provided as training data. In some embodiments, the process of FIG. 3 is performed at 203 and/or 205 of FIG. 2 by a machine learning platform such as machine learning service platform 107 of FIG. 1. In some embodiments, the input data corresponds to data related to devices of an environment such as customer network environment 111 of FIG. 1.

At 301, historical data is generated using a trained reconstruction model. For example, a set of input data corresponding to historical data is generated using a trained machine learning model for reconstructing an original set of input data. In various embodiments, a version of the original set of input data is reconstructed by applying a sample data set of the original data to the trained machine learning model. The sampled data set preserves characteristics and/or properties of the original data but is smaller in size than the original data set. For example, the sampled data may contain fewer elements than the original data and/or the sampled data may have a smaller storage requirement for storing the data than the original data requires. In some embodiments, the sampled data can be an anomaly preserving version of the original input data that oversamples the values that are outliers. When used as input data for the trained reconstruction model, the trained reconstruction model can generate a version of the original data that includes the preserved characteristics and/or properties, such as anomalies. In some embodiments, the trained reconstruction model is an autoencoder. In various embodiments, the original input data and the generated version of the input data are both time-series data.

At 303, optional additional time-series data is received. For example, additional time-series data can be provided and is received at 303. The new data can correspond to updated data and may be the most recent data collected. In some embodiments, the additional time-series data is data that falls within a time window that conforms to data retention policies. For example, any data outside the time window allowed by data retention policies is excluded from the additional time-series data. In various embodiments, the historical data generated at 301 combined with the additional time-series data received at 303 represent a complete perspective of the type of data values that can be expected for the machine learning problem.

At 305, the training data is prepared. For example, the data generated at 301 and any optional additional data received at 303 are prepared as training data. In some embodiments, the data is normalized and/or formatted to conform with the requirements of the training platform for training a machine learning model. In some embodiments, missing values present in the training data may be filled in, for example, with the mean value of a metrics or another appropriate value. In various embodiments, the two data sets are merged to create a single training data set. In some embodiments, the prepared training data includes training, validation, and/or test data sets.

At 307, the prepared training data is provided. For example, the prepared training data is provided for training a machine learning model. The training data can be used to train a custom machine learning model for a machine learning problem such as a multi-variate deep learning model for anomaly detection. In some embodiments, the training data can be further stored for future training. For example, using the disclosed techniques, the training data can be sampled to create a sampled data set of the training data that preserves characteristics and/or properties of the training data such as anomalies. The sampled data can be later used to generate a version of the training data, at step 301, by providing the sampled data to a trained reconstruction model. In some embodiments, the reconstruction model is trained using the training data and the sampled data.

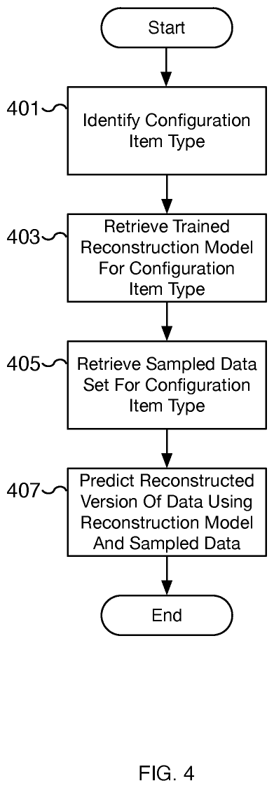

FIG. 4 is a flow chart illustrating an embodiment of a process for generating a reconstructed version of time-series data. For example, using the process of FIG. 4, a version of an original data set can be generated (or reconstructed) using a trained machine learning model. In various embodiments, the reconstructed data preserves the properties and/or characteristics of the original data, such as the existence and frequency of anomalous values. By preserving the profile of the original data, the reconstructed data can be generated and used as training data in place of the original data. In particular embodiments, both the original data and the reconstructed data are time-series data, such as metrics collected by monitoring devices of a network environment. In the example shown, the reconstructed data is generated based on a specified configuration item type associated with the required machine learning solution. For example, based on the configuration item type, a corresponding sampled data set and a reconstruction model are utilized to generate the appropriate reconstructed data. In some embodiments, the process of FIG. 4 is performed at 203 and/or 205 of FIG. 2 and/or at 301 of FIG. 3 by a machine learning platform such as machine learning service platform 107 of FIG. 1. In some embodiments, the input data corresponds to data related to devices of an environment such as customer network environment 111 of FIG. 1. In some embodiments, a sampled data set and corresponding reconstruction model are stored and/or retrieved from a data store such as database 109 of FIG. 1.

At 401, the configuration item type is identified. For example, the specific configuration item type for which reconstructed data is requested is identified. In some embodiments, the reconstructed data is dependent on the configuration item type since different configuration item types can utilize different input features with different corresponding profiles for their respective values. For example, when detecting anomalies, the corresponding monitored metrics are different as well as their associated anomalous values depending on the configuration item type of a monitored asset or configuration item. In some embodiments, a configuration item is assigned one or more configuration item types and the configuration item type is retrieved based on a unique identifier of the configuration item.

At 403, a trained reconstruction model is retrieved for the identified configuration item type. For example, based on the identified configuration item type, a trained reconstruction model is retrieved for use in generating the reconstructed version of data for the configuration item type. In some embodiments, different reconstruction models are trained for each different configuration item type and the appropriate model is retrieved. For example, in some deployment scenarios, the number of different trained models exceeds the number that can be actively maintained in memory. When a desired model is needed, the model is retrieved from storage and loaded into memory. In some embodiments, an existing model loaded in memory may need to be evicted in order to have sufficient memory to load the newly retrieved reconstruction model. In some embodiments, a universal reconstruction model is utilized and the same universal model can be used for different configuration item types rather than a specific model for each configuration item type. In some embodiments, the trained reconstruction model is an autoencoder.

At 405, a sampled data set is retrieved for the identified configuration item type. For example, based on the identified configuration item type, a sampled data set is retrieved for the identified configuration item type for use in generating the reconstructed version of data for the configuration item type. In various embodiments, the sampled data set is a data set that is smaller in size than the original data set and one that preserves certain characteristics and/or properties of the original data, such as anomalies and/or their corresponding statistical properties. In some embodiments, the sampled data set is specific for each configuration item type and the sampled data set is retrieved for use with the corresponding trained reconstruction model retrieved at 403. In some embodiments, the different sampled data sets for the different configuration item types exceed the number that can be actively maintained in memory and each sampled data set is retrieved and loaded into memory when needed.

At 407, a reconstructed version of data is predicted using the retrieved trained reconstruction model and the sampled data set. For example, using the trained reconstruction model retrieved at 403 and the sampled data set retrieved at 405, a reconstructed version of an original data set is generated for the identified configuration item type. In various embodiments, the sampled data set is applied as input feature data for the trained reconstruction model to predict a version of the original data. The generated reconstructed data has the same characteristics and/or properties of the original data and is useful as a substitute for the original data. In various embodiments, the reconstructed data preserves the distribution and statistical properties of the original data such as the existing and frequency of anomalies in the original data but may not have the same exact values of the original data. In various embodiments, the reconstructed version of the data is generated and provided as training data. For example, the reconstructed data can correspond to and represent historical data that can be used to train a machine learning model.

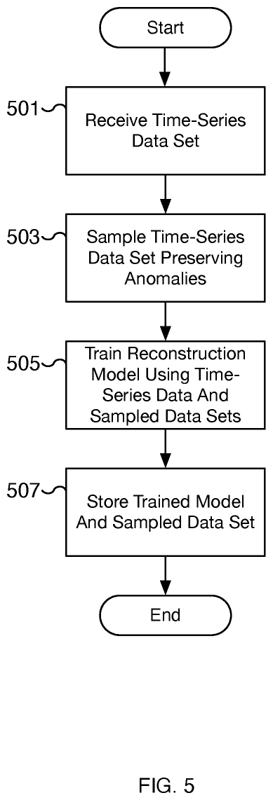

FIG. 5 is a flow chart illustrating an embodiment of a process for creating a model for reconstructing time-series data. For example, using the process of FIG. 5, provided time-series data can be used to train a reconstruction model that can reconstruct a version of the original time-series data that maintains the characteristics and/or properties of the original data. In some embodiments, the process is used in part to anonymize and/or compress the original data by storing the trained reconstruction model along with a sampled data set of the original data as an alternative to storing the original data. For example, the trained model and sampled data set pair may preserve characteristics and/or properties of the original data without privacy, security, and/or data retention concerns associated with storing the original data. In some embodiments, the process of FIG. 5 is performed as part of a machine learning solution and the trained reconstruction model and associated sampled data set can be utilized by the processes for FIGS. 2-4. For example, the reconstruction model and associated sampled data set can be utilized to generate historical data as input data. In some embodiments, the process of FIG. 5 is performed by a machine learning platform such as machine learning service platform 107 of FIG. 1. In some embodiments, the time-series data corresponds to data related to devices of an environment such as customer network environment 111 of FIG. 1. In some embodiments, once created, a reconstruction model and associated sampled data set pair are stored in a data store such as database 109 of FIG. 1.

At 501, a time-series data set is received. For example, a data set consisting of one or more time-series values is received. In some embodiments, the number of different values or features for the data set can be tens, hundreds, or more different values for use as different input features for machine learning. For example, metrics collected when monitoring a device and/or environment for anomalies can include multiple hundreds of different metrics such as CPU speed, CPU temperature, memory usage, network utilization, swap size, and the running processes, among others. In various embodiments, the received time-series data is collected at regular time intervals such as every certain number of seconds and/or minutes. Moreover, the received time-series data can span a long window of time such as days, months, or years.

At 503, the time-series data set is sampled and anomalies within the time-series data are preserved. For example, the received time-series data set is sampled to create a sampled data set that is smaller in size than the original data set. In some embodiments, the sampled data set is a lower size than the received original time-series data set. For example, the sampled data set may contain fewer elements than the original data set and/or may require a smaller amount of storage to store the corresponding sampled data than is required to store the original data set. The techniques applied sample the received data in a manner that preserves the characteristics and/or properties of the original time-series data, such as the anomalies, their values, and/or their distribution. In various embodiments, the sampling preserves the statistical properties of the values of the original time-series data set, such as the statistical distribution of anomalies and/or outlier values. In some embodiments, the received time-series data set is first analyzed to determine the distribution of values and the anomalous and/or outlier values are oversampled compared to their frequency of their occurrences in order to preserve their representation to allow a version of the original time-series data to be generated from the sampled data set.

At 505, a reconstruction model is trained using the time-series data and the sampled data sets. For example, a machine learning model is trained using the time-series data set received at 501 and the sampled data set sampled at 503 from the original data set. The machine learning model is a reconstruction model that is trained to reconstruct a version of the original data set, preserving the properties of the anomalies represented in the original data set. In some embodiments, the reconstruction model is an auto encoder and is customized for a specific configuration item type. In some embodiments, the model is a universal model and can be used for multiple configuration item types. In various embodiments, the trained model receives as input features the sampled data set and predicts a version of the original data set.

At 507, the trained model and sampled data set are stored. For example, the sampled data sampled at 503 and the reconstruction model trained at 505 are both stored. In various embodiments, the size of the combined reconstruction model and sampled data pair is significantly smaller in size then the original data set received at 501. Moreover, by storing the combined reconstruction model and sampled data pair, the original data set does not need to be retained and can be securely purged from the system. In some embodiments, the combined reconstruction model and sampled data pair are stored using one or more indices that map a configuration item type to the combined reconstruction model and sampled data pair. For example, when provided with a configuration item and/or a configuration item type, the corresponding combined reconstruction model and sampled data pair can be identified and retrieved, for example, from their corresponding data stores. In some embodiments, the configuration item type associated with the original time-series data is mapped to the pairing of the sampled data and the trained reconstruction model.

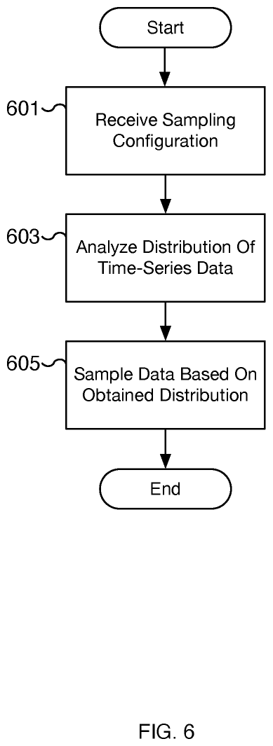

FIG. 6 is a flow chart illustrating an embodiment of a process for creating a sampled data set that preserves anomalies. For example, using the process of FIG. 6, a time-series data set is sampled to create a sampled version of the original time-series data that preserves anomalies and/or other properties or characteristics of the original data. For example, the sampled data set can preserve the anomalous values found in the original data set along with the characteristics of their distribution such as their statistical properties. In some embodiments, an anomaly preserving sampled data set is used to reconstruct a version of the original data using a trained reconstruction model. In some embodiments, the process of FIG. 6 is performed at 503 of FIG. 5 by a machine learning platform such as machine learning service platform 107 of FIG. 1. In some embodiments, the time-series data that is sampled corresponds to data related to devices of an environment such as customer network environment 111 of FIG. 1.

At 601, a configuration for sampling is received. For example, parameters for preserving the characteristics of a set of data are received. The parameters can include what properties to preserve when sampling the data to create a sampled data set. For example, the sampling configuration can specify to preserve anomalies and/or outliers. In some embodiments, the properties are specified using statistical metrics, such as the number of anomalies and/or type of anomalies to preserve based on statistical properties of the data set.

At 603, the distribution of the time-series data is analyzed. For example, the data is analyzed to determine the distribution of the data based on individual metrics and/or combined metrics. In various embodiments, the determined distribution can determine where values in the time-series data lie relative to the other values. For example, the mean, standard deviation, and mode of the time-series data for each metric can be determined along with the distance a value is from the mean. In some embodiments, the analyzed distribution separates values in time-series data by their distance to the computed standard deviation. In some embodiments, threshold values are determined that correspond to different statistical distributions within the data set, such as −3, −2, −1, 1, 2, or 3 standard deviations from the mean. The values within the data set can then be separated and/or binned based on the determined threshold values.

At 605, the time-series data is sampled based on the obtained distribution. For example, the data is sampled using the distribution obtained at 603 to preserve certain properties of the data set such as anomalies. In some embodiments, the values of the data set are binned based on the obtained distribution and statistical threshold values and each bin of values within the data set is sampled equally such that underrepresented values are oversampled relative to their frequency of occurrence. For example, the number of samples taken from a bin between two and three standard deviations from the mean is equal to or greater than the number of samples taken from a bin within one standard deviation from the mean. In various embodiments, the sampling technique utilizes the analyzed statistical distribution of the data set to preserve statistical properties and/or characteristics of the data set such as the existence and frequency of anomalies and/or outlier values. In various embodiments, the sampled data set is an anomaly preserving data set of the original time-series data.

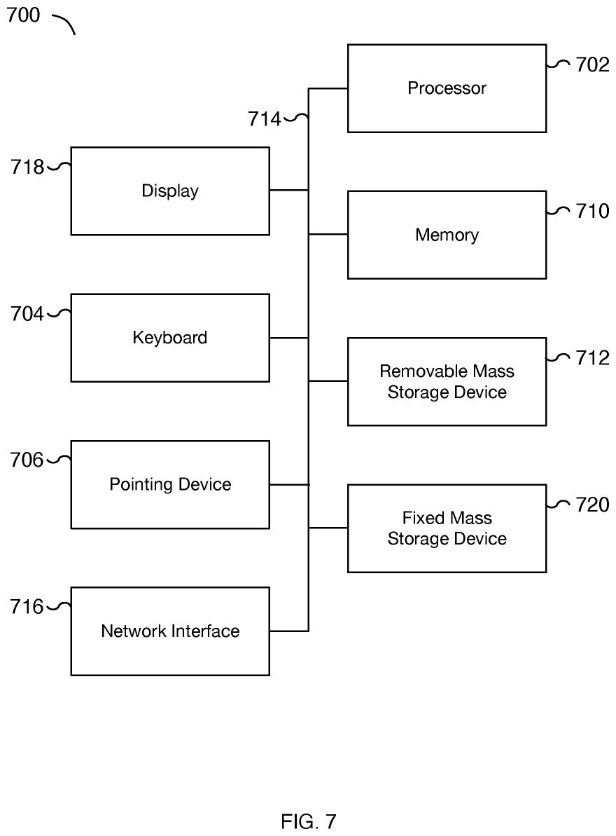

FIG. 7 is a functional diagram illustrating a programmed computer system for providing a machine learning solution. As will be apparent, other computer system architectures and configurations can be utilized for providing a machine learning solution including those with one or more graphical processing units (GPUs). Examples of computer system 700 include client 101 of FIG. 1, one or more computers of machine learning service platform 107 of FIG. 1, one or more computers of database 109 of FIG. 1, and/or one or more devices/servers of customer network environment 111 of FIG. 1 including internal server 121 and/or devices 123, 125, 127, and/or 129 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2-6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
obtaining a distribution of values of time-series data;
based on the distribution of the values, sampling the time-series data to generate an anomaly preserving version of the time-series data; and
generating, via a trained machine learning model, a reconstructed version of the time-series data based on the anomaly preserving version of the time-series data.

2. The method of claim 1, further comprising storing the anomaly preserving version of the time-series data.

3. The method of claim 1, further comprising analyzing a property of the time-series data including by using the reconstructed version of the time-series data.

4. The method of claim 1, wherein the anomaly preserving version of the time-series data is a smaller size than the time-series data.

5. The method of claim 1, wherein generating the reconstructed version of the time-series data includes providing the anomaly preserving version of the time-series data to the trained machine learning model.

6. The method of claim 1, further comprising:
providing the time-series data and the anomaly preserving version of the time-series data to train the trained machine learning model.

7. The method of claim 1, wherein the trained machine learning model is a multi-variate machine learning model.

8. The method of claim 1, further comprising:
pairing the anomaly preserving version of the time-series data and the trained machine learning model;
mapping a configuration item type of a plurality of different configuration item types to the pairing of the anomaly preserving version of the time-series data and the trained machine learning model; and
storing the mapping for the configuration item type.

9. The method of claim 8, further comprising:
receiving an identifier of a configuration item of the configuration item type;
retrieving the pairing of the anomaly preserving version of the time-series data and the trained machine learning model mapping for the configuration item type;
retrieving the anomaly preserving version; and
retrieving the trained machine learning model.

10. The method of claim 1, further comprising training a multi-variate machine learning model for anomaly detection using at least the reconstructed version of the time-series data as machine learning model training data.

11. A system comprising:
one or more processors; and
a memory coupled to the one or more processors, wherein the memory is configured to provide the one or more processors with instructions which when executed cause the one or more processors to:
obtain a distribution of values of time-series data;
based on the distribution of the values, sample the time-series data to generate an anomaly preserving version of the time-series data; and
generate, via a trained machine learning model, a reconstructed version of the time-series data based on the anomaly preserving version of the time-series data.

12. The system of claim 11, wherein the memory is further configured to provide the one or more processors with instructions which when executed cause the one or more processors to store the anomaly preserving version of the time-series data.

13. The system of claim 11, wherein the memory is further configured to provide the one or more processors with instructions which when executed cause the one or more processors to analyze a property of the time-series data including by using the reconstructed version of the time-series data.

14. The system of claim 11, wherein the anomaly preserving version of the time-series data is a smaller size than the time-series data.

15. The system of claim 11, wherein generating the reconstructed version of the time-series data includes providing the anomaly preserving version of the time-series data to the trained machine learning model.

16. The system of claim 11, wherein the memory is further configured to provide the one or more processors with instructions which when executed cause the one or more processors to provide the time-series data and the anomaly preserving version of the time-series data to train the trained machine learning model.

17. The system of claim 11, wherein the trained machine learning model is a multi-variate machine learning model.

18. The system of claim 11, wherein the memory is further configured to provide the one or more processors with instructions which when executed cause the one or more processors to:
pair the anomaly preserving version of the time-series data and the trained machine learning model;
map a configuration item type of a plurality of different configuration item types to the pairing of the anomaly preserving version of the time-series data and the trained machine learning model; and
store the mapping for the configuration item type.

19. The system of claim 11, wherein the memory is further configured to provide the one or more processors with instructions which when executed cause the one or more processors to train a multi-variate machine learning model for anomaly detection using at least the reconstructed version of the time-series data as machine learning model training data.

20. A computer program product, the computer program product being embodied in a non-transitory computer readable storage medium and comprising computer instructions for:
obtaining a distribution of values of time-series data;
based on the distribution of the values, sampling the time-series data to generate an anomaly preserving version of the time-series data; and
generating, via a trained machine learning model, a reconstructed version of the time-series data based on the anomaly preserving version of the time-series data.
